(19) United States
(12) Patent Application Publication
(10) Pub. No.: US 2009/0114796 A1
(43) Pub. Date: May 7, 2009

(54) MULTIPURPOSE CERAMIC CAKE MOLD

(76) Inventor: SHAO-CHIU LIN, Taipei City (TW)

Correspondence Address: LEONG C LEI, PMB # 1008, 1867 YGNACIO VALLEY ROAD, WALNUT CREEK, CA, 94598, US

(21) Appl. No.: 11/933,438

(22) Filed: Nov. 1, 2007

(51) Int. Cl. B28B 7/34

(52) U.S. Cl. 249/134

(57) ABSTRACT

A ceramic cake mold for molding a cake as well as for use as a wall ornament or display body is disclosed having a front side, a back side opposite to the front side, a cavity formed in the front side and having a three-dimensional design for molding a cake, a rim extending around the border of the cavity with a hanging hole for hanging, and a three-dimensional design formed in the back side in a complementary relationship relative to the three-dimensional design of the cavity, and a color painting formed on the outer surface thereof beyond the three-dimensional design formed in the back side.

### BACKGROUND OF THE INVENTION

(a) Technical Field of the Invention

The present invention relates generally to apparatus for making cakes and more particularly, to a multipurpose ceramic cake mold.

(b) Description of the Prior Art

Conventional cake molds are commonly made out of metal, having a cavity for molding a cake to show a particular three-dimensional design. When a cake mold is not in use, it cannot be used for other purposes, and the user may receive the cake mold in a drawer or cabinet and hang the cake mold on the wall in the kitchen.

### SUMMARY OF THE INVENTION

The primary purpose of the present invention is to provide a ceramic cake mold that can be used as a food container for holding foods, a cooking utensil for cooking foods, or a wall ornament or display body for decoration purpose when it is not used for making a cake.

According to one aspect of the present invention, the ceramic cake mold has a front side, a back side opposite to the front side, a cavity formed in the front side and having a three-dimensional design for molding a cake, a rim extending around the border of the cavity with a hanging hole for hanging, and a three-dimensional design formed in the back side in a complementary relationship relative to the three-dimensional design of the cavity, and a color painting formed on the outer surface thereof beyond the three-dimensional design formed in the back side.

According to another aspect of the present invention, the three-dimensional design of the cavity is a relief design, and the three-dimensional design in the back side is an offset design. In an alternate form of the present invention, the three-dimensional design of the cavity is an offset design, and the three-dimensional design in the back side is a relief design.

According to still another aspect of the present invention, the rim has at least one hanging hole for hanging.

According to still another aspect of the present invention, the outer surface of the ceramic cake mold has the shape of a character, vehicle, plant, fruit, or any of a variety of display toys.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front plain view of a ceramic cake mold in accordance with the present invention.

FIG. 2 is a rear plain view of the ceramic cake mold in accordance with the present invention.

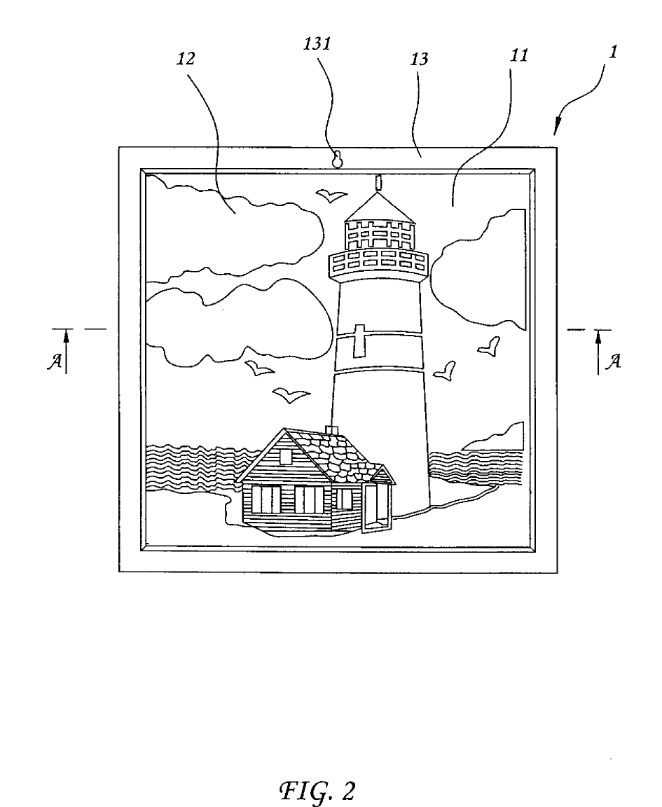

FIG. 3 is a sectional view taken along line A-A of FIG. 2.

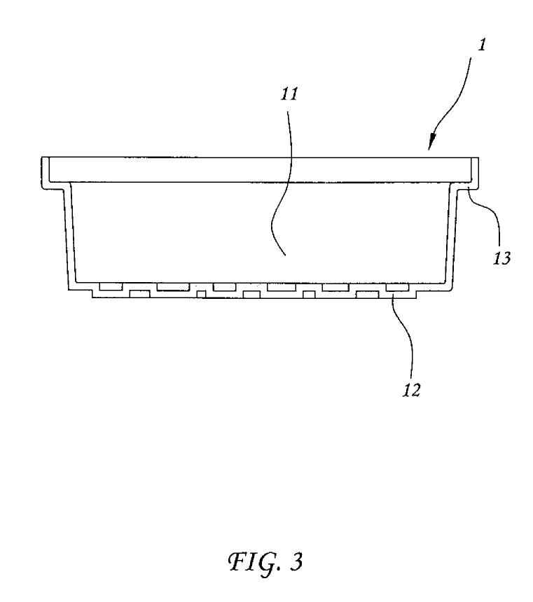

FIG. 4 is a schematic drawing showing the ceramic cake mold hung on the work and used as a wall ornament.

FIG. 5 is a schematic drawing of the present invention, showing the ceramic cake mold made in the form of a car model.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

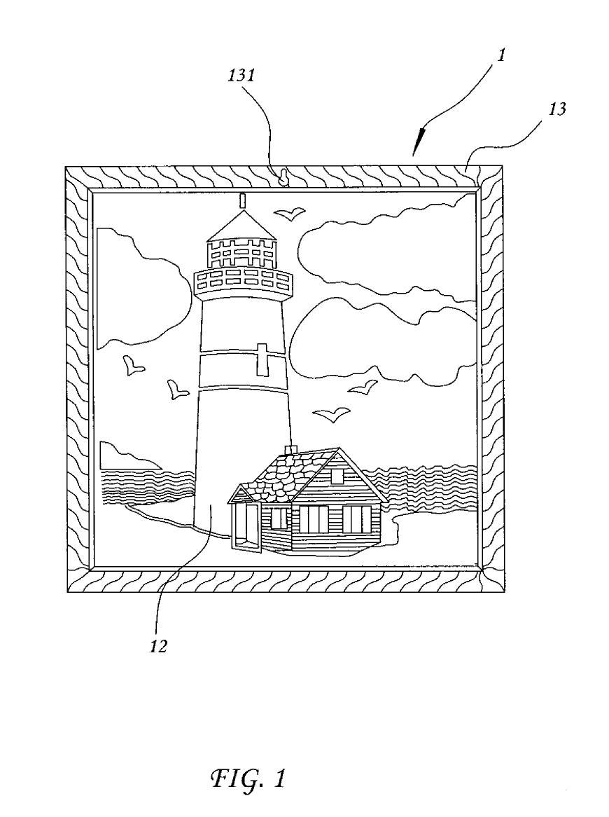

Referring to FIGS. 1˜3, a multipurpose ceramic cake mold 1 in accordance with the present invention is shown made out of ceramics, comprising a cavity 11 in the front side for molding a cake, a rim 13 around the border of the cavity 11, at least one hanging hole 131 on the rim 13, and a three-dimensional design 12 in the back side (the outer surface of the bottom wall of the cavity 11). The three-dimensional design 12 can be a relief design or offset design in a complementary relationship relative to the three-dimensional design of the cavity 11. The outer surface of the body of the ceramic cake mold 1 as well as the rim 13 carry a pattern, letters, signs, . . . etc. Before sintering of the raw cake mold, the outer surface of the raw cake mold is painted subject to the designed pattern, letters, signs, . . . etc., and then the raw cake mold is sintered, forming the desired multipurpose ceramic cake mold.

When making a cake, prepared food materials are put in the cavity 1, and then the ceramic cake mold is put in a baking oven and baked. After baking, the cake is removed from the ceramic cake mold, and the cake thus obtained has a design corresponding to the three-dimensional design 12 of the cavity 11.

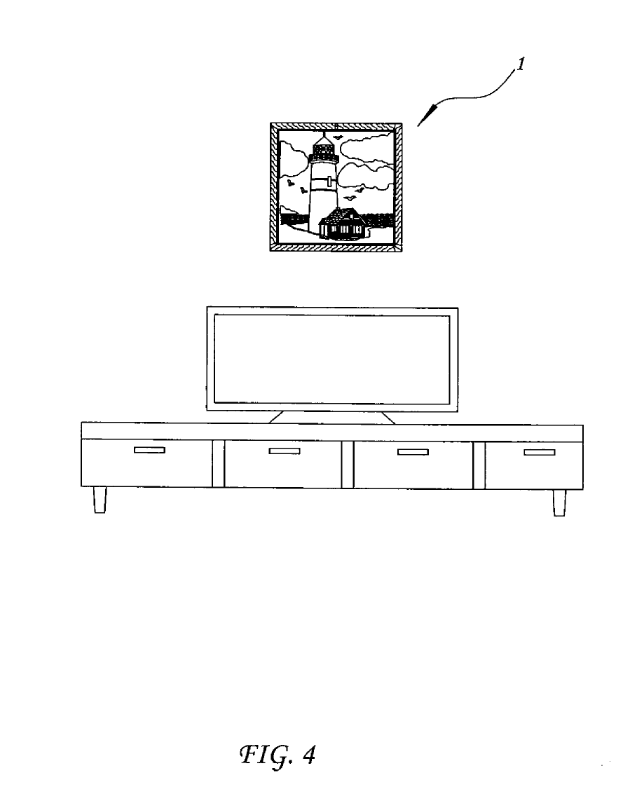

Referring to FIG. 4, after well washed, the ceramic cake mold 1 can be hung on a wall by means of the hanging hole 131 and used as a wall ornament to decorate the wall.

The ceramic cake mold 1 can also be used as a food container to hold soup, rice, vegetables, fruits, . . . etc. The ceramic cake mold 1 can also be used as a cooking vessel for cooking foods on a stove.

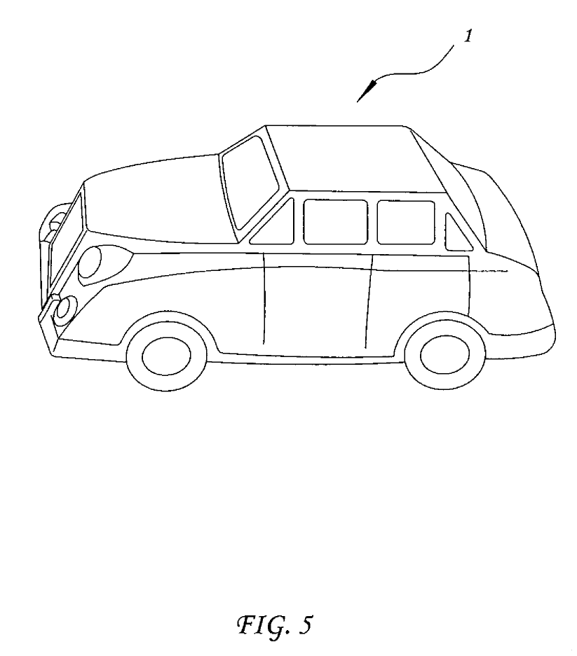

Referring to FIG. 5, the ceramic cake mold 1 can be made in the form of a car model. When the ceramic cake mold 1 is not used for making a cake, it can be placed in a show window and used as a display toy.

Although particular embodiments of the invention have been described in detail for purposes of illustration, various modifications and enhancements may be made without departing from the spirit and scope of the invention. For example, oscillator means may be used to atomize water into a fine spray. Accordingly, the invention is not to be limited except as by the appended claims.

It will be understood that each of the elements described above, or two or more together may also find a useful application in other yes of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A ceramic cake mold comprising a front side, a back side opposite to said front side, a cavity formed in said front side for molding a cake, said cavity showing a three-dimensional design, a rim extending around the border of said cavity, and a three-dimensional design formed in said back side in a complementary relationship relative to three dimensional design of said cavity, and a color painting formed on the outer surface thereof beyond three dimensional design formed in said back side.

2. The ceramic cake mold as claimed in claim 1, wherein the three-dimensional design of said cavity is a relief design, and the three-dimensional design in said back side is an offset design.

3. The ceramic cake mold as claimed in claim 1, wherein the three-dimensional design of said cavity is an offset design, and the three-dimensional design in said back side is a relief design.

4. The ceramic cake mold as claimed in claim 1, wherein said rim has at least one hanging hole.

5. The ceramic cake mold as claimed in claim 1, wherein the outer surface of the ceramic cake mold has the shape of a car model.
